(19) United States
(12) Patent Application Publication
(10) Pub. No.: US 2009/0136373 A1
(43) Pub. Date: May 28, 2009

(54) COMPRESSOR COMPRISING AN OSCILLATING PISTON

(76) Inventors: Robert Adler, Gerasdorf (AT); Georg Siebert, Wien (AT); Martin Stehrlein, Rust (AT)

Correspondence Address: The BOC Group, Inc., 575 MOUNTAIN AVENUE, MURRAY HILL, NJ, 07974-2082, US

(21) Appl. No.: 12/280,709

(22) PCT Filed: Feb. 13, 2007
(86) PCT No.: PCT/EP2007/001251

§ 371 Date: Oct. 10, 2008

(30) Foreign Application Priority Data
Mar. 10, 2006 (DE) 10 2006 011 560.0

(51) Int. Cl. F16N 13/20

(52) U.S. Cl. 418/63

(57) ABSTRACT

The invention relates to a compressor for cryogenic media comprising at least one compressor cylinder in which a compressor piston is arranged, wherein the compressor piston interacts with a crankshaft by means of a connecting rod. To solve the object of attaining a secure operation and of attaining a long service life of the compressor by means of low production efforts, it is proposed according to the invention that the compressor piston is embodied as an oscillating piston.

### BACKGROUND OF THE INVENTION

The invention relates to a compressor for cryogenic media comprising at least one compressor cylinder in which a compressor piston is arranged, wherein the compressor piston interacts with a crankshaft by means of a connecting rod.

For such compressors for cryogenic media, for example nitrogen, natural gas or hydrogen in each case in liquid or gaseous state, configurations are known, where the compressor piston is arranged in the compressor cylinder so as to be longitudinally displaceable so as to compress a cryogenic medium, for example natural gas or hydrogen. The compressor piston hereby performs a linear motion in the compressor cylinder. The compressor piston hereby interacts with a crankshaft by means of a connecting rod, wherein a pivot joint is required between the compressor piston and the connecting rod. A sufficient lubrication of the linear guide between compressor cylinder and compressor piston as well as of the pivot joint between connecting rod and compressor piston is to be ensured for the secure operation and for attaining a long service life of the compressor. However, in response to low cryogenic temperatures of the medium to be compressed, the lubrication of the linear guide and of the pivot joint requires an extensive construction, whereby the compressor encompasses high production costs for a secure operation and for a long service life.

### SUMMARY OF THE INVENTION

The instant invention is based on the object of providing a compressor of the afore-mentioned species, which encompasses a secure operation and a long service life with a low production effort.

According to the invention, this object is solved in that the compressor piston is embodied as an oscillating piston. By embodying the compressor piston as an oscillating piston, which performs an oscillating motion in the compressor cylinder for the purpose of compressing the cryogenic medium, the lubrication of the compressor piston can be ensured by omitting the pivot joint between the compressor piston and the connecting rod and by omitting the linear motion and thus the linear guide of the compressor piston with a simple construction, thus attaining a long service life of the compressor by means of a low production effort.

The result is a simple actuation of the compressor piston when, according to a preferred embodiment of the invention, the crankshaft is embodied as an eccentric shaft arranged in a crankshaft housing. The oscillating motion of the compressor cylinder can be attained in a simple manner by means of such an eccentric shaft.

This leads to special advantages when the oscillating piston according to an embodiment of the invention encompasses a piston head, wherein the connecting rod is rigidly connected to the piston head. The connecting rod can be embodied in one piece on the piston head, for example. A simple configuration is attained by means of low production effort due to the rigid connection of the piston head to the connecting rod, for example to a connecting rod integrally molded on the piston head.

Advantageously, the connecting rod is connected to a connecting eye, which is arranged on the eccentric shaft so as to be capable of being pivoted. The connecting rod can be connected to the connecting eye by means of a screw connection, for example, wherein the connecting eye is arranged on the eccentric shaft so as to be capable of being pivoted by means of a bearing. Through this, the oscillating piston can be connected to the eccentric shaft by means of a simple construction.

According to a preferred development of the invention, the oscillating piston is provided with at least one sealing device for the purpose of being sealed as compared to the compressor cylinder.

According to an advantageous embodiment, the sealing device is provided with a convex outer surface. A seal between the compressor piston and the cylinder wall of the compressor cylinder is attained in a simple manner and in response to small frictional losses in response to the oscillating motion carried out by the compressor cylinder by means of a convex outer surface of the sealing device.

According to an advantageous development of the invention, provision is made for the sealing device to interact with a spring device. By means of a spring device, the compressive force of the sealing device on the cylinder wall of the compressor cylinder can be increased in a simple manner, thus attaining a secure seal.

Advantageously, the spring device is embodied as a sinuous spring.

According to an advantageous embodiment of the invention, the oscillating piston is provided with a groove-shaped recess, which is arranged in peripheral direction on the piston head and in which the sealing device is arranged. The sealing device can be arranged in such a groove-shaped recess in a simple manner.

The spring device can also be arranged in this groove-shaped recess in a simple manner.

In a development of the invention, provision is made for the crankshaft housing to be connected to a temporary storage container, which is acted upon by an initial pressure generated by the compressor. It is attained through this that the lower side of the piston head, which is arranged opposite to the piston upper side arranged in the compressor chamber formed by the compressor cylinder and the compressor piston, is acted upon by the initial pressure generated by the compressor, whereby the connecting rod in the compressor stroke must only transfer low compressive forces and can be dimensioned so as to be appropriately small.

Particular advantages can be attained when, according to an embodiment of the invention, the temporary storage container is formed by a pressure capsule, which accommodates the compressor. The arrangement of the compressor in a pressure capsule makes it possible for leaks and leakages of the compressor not to be released into the environment but to be stored in the pressure capsule. Furthermore, the pressure capsule can assume the function of a temporary storage container, whereby a separate temporary storage container, for example additional temporary storage bottles can be omitted. By means of the pressure capsule, which has the function of the temporary storage container, it can furthermore be attained by means of a simple connecting hole in the crankshaft housing that the crankshaft housing and thus the lower side of the piston is acted upon by the initial pressure of the compressor.

According to an advantageous development of the invention, provision is made for the compressor to encompass a cylinder head, in which an inlet duct and an outlet duct are embodied, wherein an inlet valve is assigned to the inlet duct and an outlet valve is assigned to the outlet duct and wherein the inlet duct is provided with a throttling device. By means of such a throttling device assigned to the inlet duct, for example a throttle hole of the inlet duct embodied in the cylinder head, it is attained in a simple manner that a pressure drop occurs at the throttling location formed by the throttling hole. In response to an oncoming liquid medium, this pressure drop is high due to the greater density of the medium, whereby the medium transitions into the gaseous state. In response to an oncoming gaseous medium, the pressure drop which occurs is appropriately small. It is thus attained by means of the throttling location that a virtually constant input density and input temperatures of the compressor can be maintained in response to an oncoming liquid medium as well as in response to an oncoming gaseous medium.

Further advantages and details will be specified in detail by means of the exemplary embodiment illustrated in the diagrammatic figures.

### BRIEF DESCRIPTION OF THE DRAWINGS

FIG. 1 shows a compressor according to the invention in a perspective longitudinal sectional view,

FIG. 2a shows the compressor in the upper dead center,

FIG. 2b shows the compressor in the intake stroke,

FIG. 2c shows the compressor in the lower dead center,

FIG. 2d shows the compressor in the compressor stroke,

FIG. 3 shows the compressor piston in a partial view,

FIG. 4 shows the sectional view through the cylinder head and

FIG. 5 shows the sinuous spring in a top view.

### DETAILED DESCRIPTION OF THE INVENTION

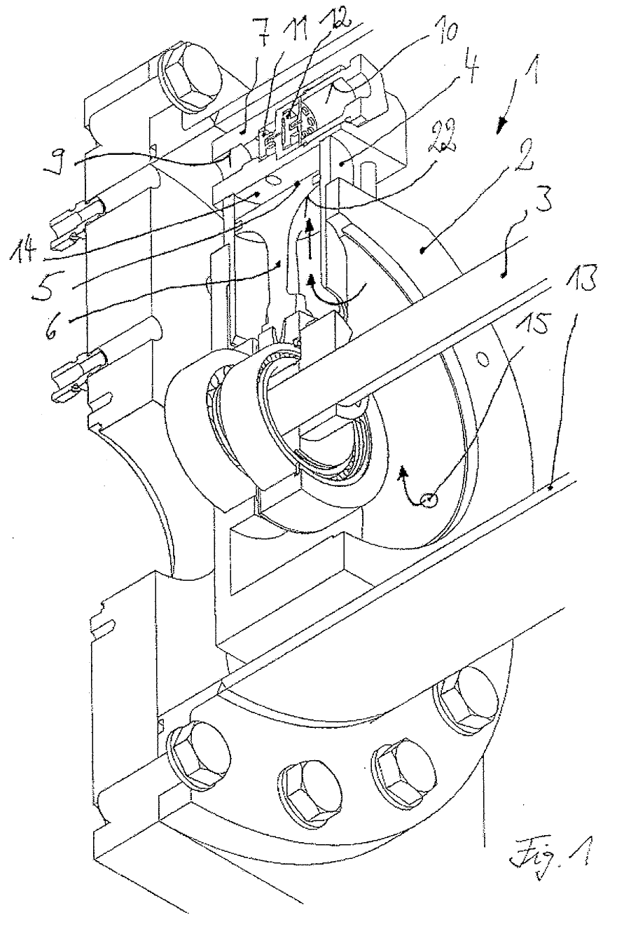

A compressor 1 according to the invention is illustrated in FIG. 1 in a longitudinal sectional view. The compressor encompasses a crankshaft housing 2, in which a crankshaft 3 is supported so as to be capable of being pivoted. A compressor cylinder 4, in which a compressor piston 5 is arranged, is arranged on the crankshaft housing 2. A compressor chamber 14 is embodied between the compressor cylinder 4 and the compressor piston.

The compressor piston 5 encompasses a connecting rod 6, by means of which the compressor piston 5 interacts with the crankshaft 3. A cylinder head 7, in which an inlet duct 9 and an outlet duct 10 are embodied, is arranged on the compressor cylinder 4. An inlet valve 11 is arranged in the inlet duct 9. The outlet duct 10 is provided with an outlet valve 12.

The compressor 1 is surrounded by a pressure capsule 13, which is formed by a housing surrounding the compressor 1. The pressure capsule 13 is acted upon by the initial pressure generated by the compressor and has the function of a temporary storage container. The crankshaft housing 2 is provided with a connecting duct 15, for example a connecting hole, which establishes a connection of the pressure capsule 13 to the interior of the crankshaft housing 2. It is achieved through this that the piston lower side 22 of the compressor piston 5 is acted upon by the initial pressure of the compressor 1, which is present in the pressure capsule 13.

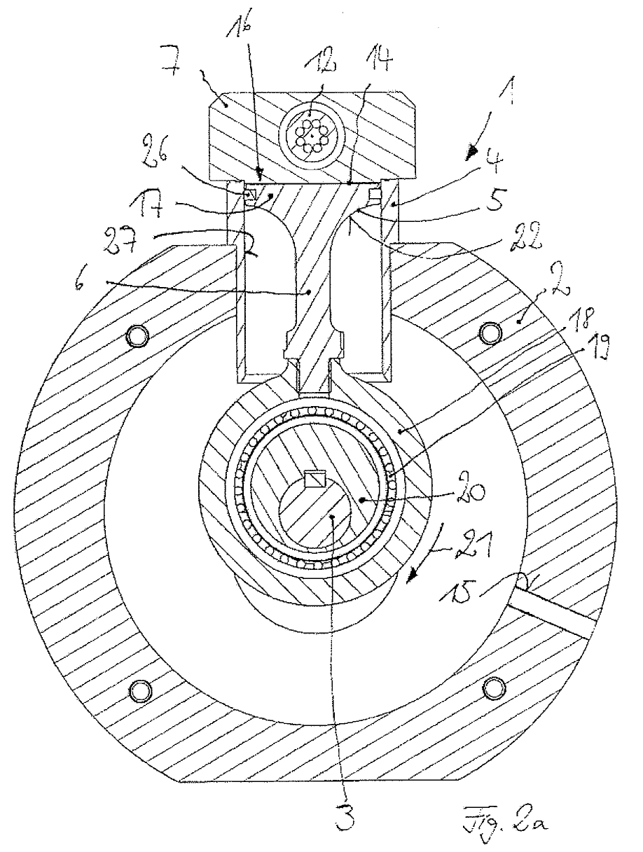

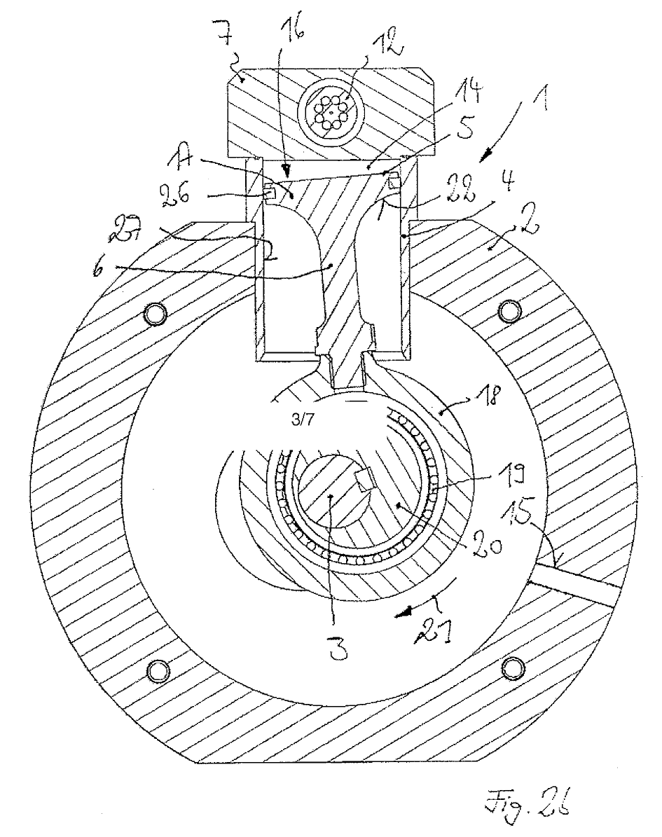

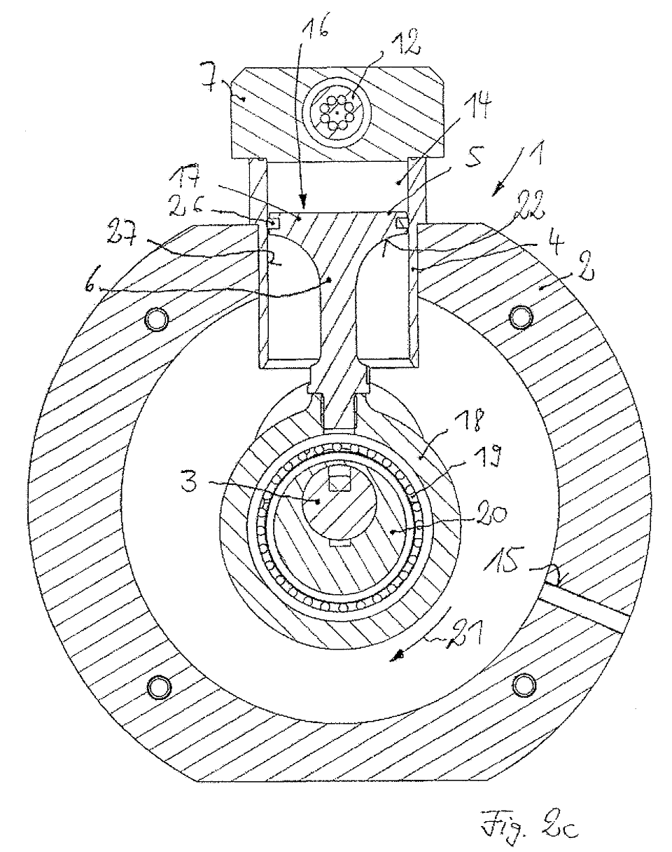

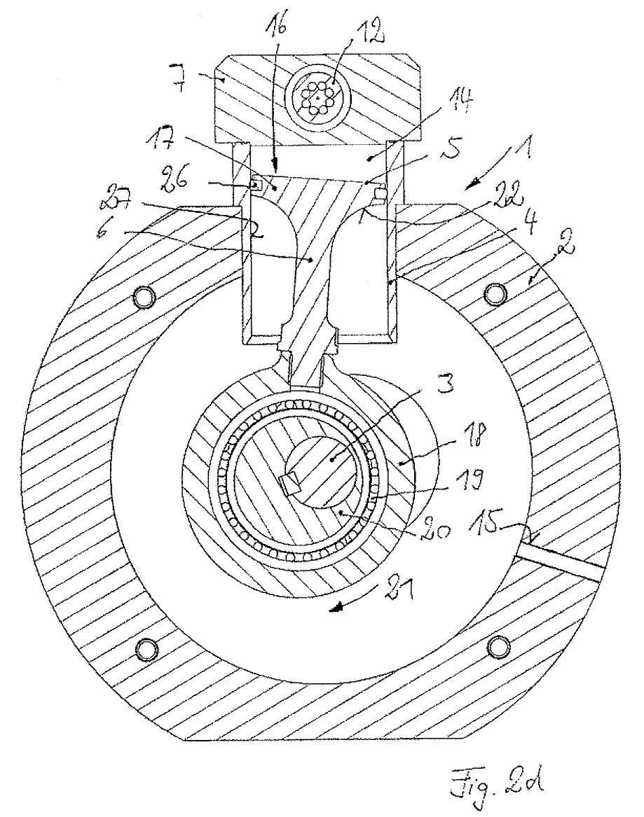

As is shown in FIGS. 2a to 2d, the compressor piston 5 is embodied as an oscillating piston 16 according to the invention, which encompasses a piston head 17, on which the connecting rod 6 is integrally molded in one piece. The connecting rod 6 is fastened to a connecting eye 18, for example by means of a screw connection. Said connecting eye 18 is supported on the crankshaft 3 by means of a bearing 19 so as to be capable of being pivoted. The crankshaft 3 is hereby embodied as an eccentric shaft comprising an eccentric 20, which is arranged on the crankshaft 3 and on which the bearing 19 and thus the connecting eye 18 is arranged. The compressor piston 5 is provided with a sealing device 26, which abuts on the cylinder wall 27 of the compressor cylinder 4.

In FIG. 2a, the compressor 1 is illustrated in the upper dead center. In response to a pivoting of the crankshaft 3 in the direction 21, the compressor 1 reaches the intake stroke illustrates in FIG. 2b, in which a medium, which is to be compressed via the inlet duct 9, flows into the compressor chamber 14 formed between the compressor piston 5 and the compressor cylinder 4. In response to a further pivoting of the crankshaft 3 in the direction 21, the compressor 1 reaches the compressor stroke illustrated in FIG. 2d, in which a compressed medium is conveyed into the outlet duct 10, via the lower dead center illustrated in FIG. 2c. By connecting the interior of the crankshaft housing 2 to the pressure capsule 13 by means of the connecting duct 15, it is attained that the piston lower side 22 of the oscillating piston 16 is acted upon by the initial pressure, which is present in the pressure capsule 13, whereby the connecting rod 6 in the compressor stroke must only transfer low compressive forces.

The compressor piston 5 embodied as oscillating piston 16 hereby performs an oscillating motion in the intake stroke and in the compressor stroke.

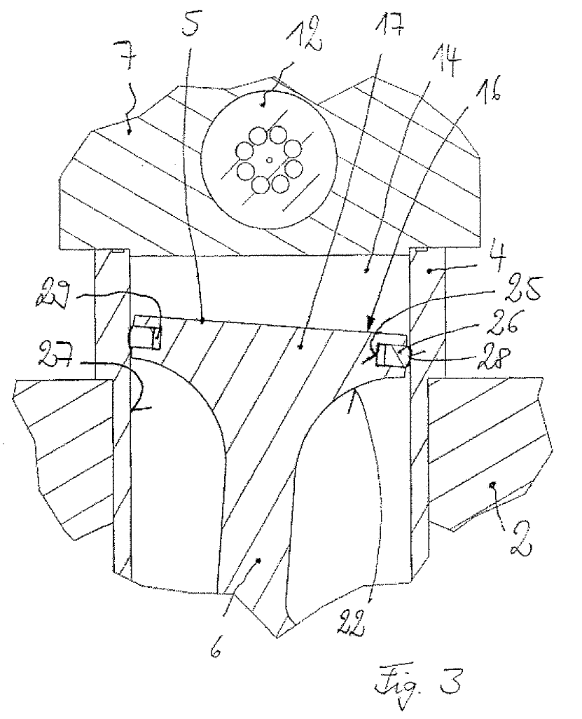

The oscillating piston 6 is illustrated in the region of the piston head 17 in FIG. 3. In the region of the piston head 6, the oscillating piston 16 is provide with a groove-shaped recess 25, which is arranged in peripheral direction and in which the sealing device 26 is arranged. The sealing device 26 is hereby provided with a convex outer surface 28, which faces the cylinder wall 27 of the compressor cylinder 4. A spring device 29, by means of which the sealing device 26 is pressed against the cylinder wall 27, is furthermore arranged in the recess 25. The compression chamber 14 is sealed in a simple manner and in response to small frictional losses in response to the oscillating motion carried out by the compressor piston 16 by means of a sealing device 26 comprising a convex outer surface, by means of which the sealing device 26 abuts on the cylinder wall 27 of the compressor cylinder 4.

The spring device 29 is hereby embodied as a sinuous spring 30 comprising an undulated shape, as is illustrated in FIG. 5.

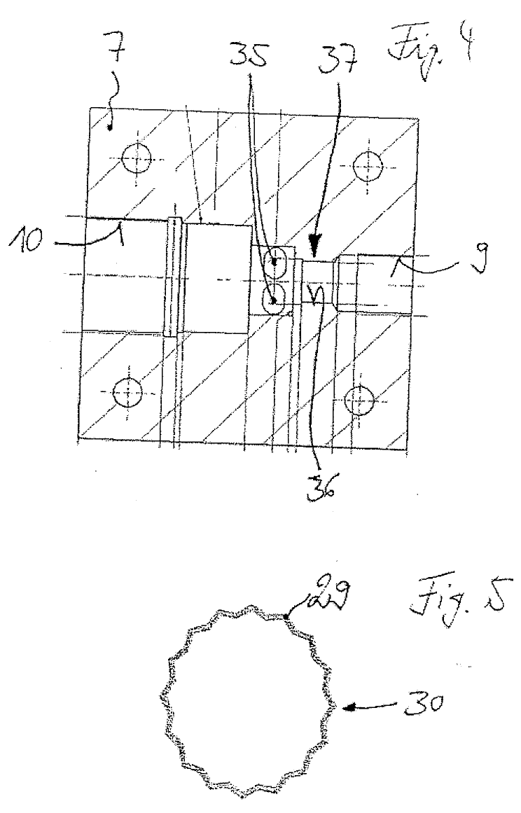

The cylinder head 7 is illustrated in a longitudinal sectional view in FIG. 4. The cylinder head 7 is provided with the inlet duct 9 and the outlet duct 10 and encompasses connecting holes 35 for the purpose of connecting the inlet duct 9 and the outlet duct 10, respectively, to the compressor chamber 14.

The inlet duct 9 is provided with a diameter constriction 36, which forms a throttling device 37 for the incoming medium. By means of this throttling device 37 it is attained that the compressor 1 can be operated with a virtually constant input density and input temperature of the medium, which is to be compressed, in response to a gaseous medium as well as in response to a liquid medium.

We claim:

1. A compressor for cryogenic media comprising at least one compressor cylinder, in which a compressor piston is arranged, wherein the compressor piston interacts with a crankshaft by means of a connecting rod, characterized in that the compressor piston is embodied as an oscillating piston.

2. The compressor according to claim 1, characterized in that the crankshaft is embodied as an eccentric shaft arranged in a crankshaft housing.

3. The compressor according to claim 1, characterized in that the oscillating piston encompasses a piston head, wherein the connecting rod is rigidly connected to the piston head).

4. The compressor according to claim 3, characterized in that the connecting rod is connected to a connecting eye, which is arranged on the eccentric shaft so as to be capable of being pivoted.

5. The compressor according claim 1, characterized in that the oscillating piston is provided with at least one sealing device for the purpose of being sealed as compared to the compressor cylinder.

6. The compressor according to claim 5, characterized in that the sealing device is provided with a convex outer surface.

7. The compressor according to claim 6, characterized in that the sealing device interacts with a spring device.

8. The compressor according to claim 7, characterized in that the spring device is embodied as a sinuous spring.

9. The compressor according to claim 5, characterized in that the oscillating piston is provided with a groove-shaped recess arranged in peripheral direction on the piston head and in which the sealing device is arranged.

10. The compressor according to claim 9, characterized in that the spring device is arranged in the groove-shaped recess.

11. The compressor according to claim 2, characterized in that the crankshaft housing is in contact with a temporary storage container, which is acted upon by the initial pressure generated by the compressor.

12. The compressor according to claim 11, characterized in that the temporary storage container is formed by a pressure capsule, which accommodates the compressor.

13. The compressor according to claim 1, characterized in that the compressor encompasses a cylinder head in which an inlet duct and an outlet duct are embodied, wherein an inlet valve is assigned to the inlet duct and an outlet valve is assigned to the outlet duct and wherein the inlet duct is provided with a throttling device.
